(19) United States
(12) Patent Application Publication
(10) Pub. No.: US 2026/0138286 A1
(43) Pub. Date: May 21, 2026

(54) ROBOT HAND, CONTROL METHOD FOR ROBOT HAND, ROBOT SYSTEM, METHOD OF MANUFACTURING ARTICLE USING ROBOT SYSTEM, AND RECORDING MEDIUM

(71) Applicant: CANON KABUSHIKI KAISHA, Tokyo (JP)

(72) Inventors: YUTA ONODA, Tochigi (JP); TOHRU KITAMURA, Kanagawa (JP)

(21) Appl. No.: 19/352,255

(22) Filed: Oct. 7, 2025

(30) Foreign Application Priority Data
Oct. 15, 2024 (JP) 2024-179624

(51) Int. Cl. B25J 15/00; B25J 9/16

(52) U.S. Cl. CPC B25J 15/0004; B25J 9/1612; B25J 9/1697; B25J 15/0042

(57) ABSTRACT

A robot hand that holds a workpiece includes at least one first member configured to hold the workpiece, and a second member configured to contact the workpiece in a state where the workpiece is held by the at least one first member. In a state where the workpiece is held by the at least one first member, an orientation of the workpiece is changed by the at least one first member or the second member being shifted.

### BACKGROUND

### Field of the Technology

The present disclosure relates to a robot hand, a control method for the robot hand, a robot system, a method for manufacturing an article using the robot system, and a recording medium.

### Description of the Related Art

When a robot hand holds or assembles a component, the orientation of the component held by the robot hand is required to be in a state in which the change in the orientation is small even while the component is being held. If the component is held or assembled in a state where the orientation of the component being held is unstable, there is a possibility that the held component may interfere with another structure or a placement portion or interfere with an assembly target, preventing assembly. In order to reduce the change in the orientation of the component held by the robot hand, it is necessary to resist the load and the moment of the component being held. For that reason, in many cases, the robot hand exerts large holding force and has high rigidity, or the robot hand is made larger in size so as to hold the component in the vicinity of both ends of the long side of the component, resulting in a significantly large hand size compared to the size and the weight of the component. As a robot hand technique for handling a component while stabilizing the orientation of the component in a manner of holding the component in the vicinity of both ends of the long side of the component, for example, Japanese Patent Laid-Open No. 2022-76937 is known.

A robot hand described in Japanese Patent Laid-Open No. 2022-76937 has a gripping portion for gripping a component, and an auxiliary portion that is movable in a direction from a palm portion of the robot hand toward the component and in a direction orthogonal to the direction. The gripping portion grips a workpiece in the vicinity of its center of gravity, and the auxiliary portion holds both ends of the long side of the workpiece. Since the gripping portion grips the workpiece in the vicinity of its center of gravity, for example, in an operation where a long component is inserted into another component to be assembled from one end of the long component and then is assembled such that the other end of the long component reaches a position near the far end of the other component to be assembled, the gripping portion however interferes with the other component to be assembled, preventing a specific assembling operation.

### SUMMARY

The present disclosure is directed to maintaining the orientation of a component even when the component is held at a fixed position.

According to an aspect of the present disclosure, a robot hand that holds a workpiece includes at least one first member configured to hold the workpiece, and a second member configured to contact the workpiece in a state where the workpiece is held by the at least one first member. In a state where the workpiece is held by the at least one first member, an orientation of the workpiece is changed by the at least one first member or the second member being shifted.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a robot system in a first embodiment.

FIG. 2 is a schematic diagram illustrating a robot hand in the first embodiment.

FIGS. 3A and 3B are schematic diagrams for describing change in the orientation of a workpiece in the first embodiment.

FIG. 4 is a schematic diagram for describing change in the orientation of the workpiece in the first embodiment.

FIG. 5 is a control flowchart in the first embodiment.

FIG. 6 is a schematic diagram illustrating the robot system in the first embodiment.

FIG. 7 is a schematic diagram illustrating the robot hand in the first embodiment.

FIGS. 8A to 8C are schematic diagrams for describing change in the orientation of a workpiece in a second embodiment.

FIGS. 9A to 9C are schematic diagrams illustrating a robot hand in a third embodiment.

FIGS. 10A and 10B are schematic diagrams illustrating a robot hand in the third embodiment.

FIGS. 11A and 11B are schematic diagrams illustrating a robot hand in the third embodiment.

FIG. 12 is a schematic diagram illustrating a robot system in a fourth embodiment.

FIG. 13 is a schematic diagram for describing change in the orientation of a workpiece in the fourth embodiment.

FIG. 14 is a control flowchart in the fourth embodiment.

FIG. 15 is a control flowchart in a fifth embodiment.

### DESCRIPTION OF THE EMBODIMENTS

Forms for implementing the present disclosure will be described below with reference to embodiments illustrated in the accompanying drawings.

The embodiments described below are merely examples, and the detailed configurations thereof can be appropriately changed by those skilled in the art without departing from the spirit of the present disclosure. The numerical values described in the embodiments are reference numerical values and do not limit the present disclosure. In the following drawings, arrows X, Y, and Z in the drawings indicate a coordinate system of the entire robot system. In general, an XYZ three-dimensional coordinate system represents a world coordinate system in the entire installation environment. In addition, depending on reason for control, a local coordinate system is employed as appropriate for a robot hand, a finger portion, joints, and the like, in some cases. In addition, in describing the robot hands according to the embodiments, embodiments of robot hands as a component holding device that performs taking-out, transferring, and assembling of a component will be used as examples. However, the applications of the robot hands according to the embodiments are not limited to the holding device.

### First Embodiment

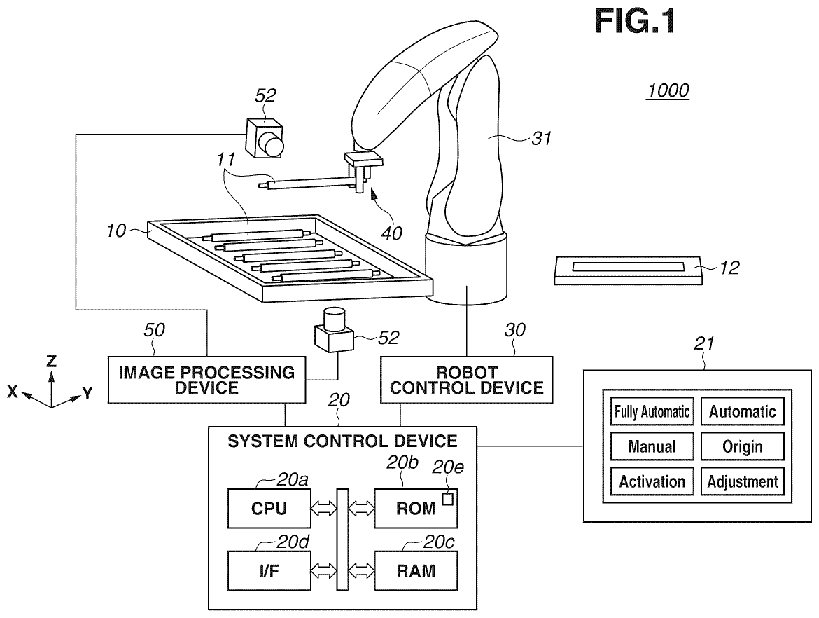

FIG. 1 is a schematic diagram illustrating a robot system 1000 according to a first embodiment. The robot system 1000 takes out each of a plurality of workpieces 11 arranged in a box 10 and transfers the workpiece 11 into a box 12.

A plurality of boxes 10 may be provided for each type of workpiece 11, and may be replaced by a conveyor, an automated guided vehicle (AGV), or the like. The box 12 is provided with partitions and the position of placing a workpiece 11 is changed for each kind of the workpieces 11, so that the box 12 can be used as a device for collecting workpieces necessary for assembling a product. The box 12 illustrated in FIG. 1 is provided with a nest of a workpiece 11, and it is assumed that holding members 42 will interfere with the box 12 unless an end portion of the workpiece 11 is held. Further, in addition to the configuration that a workpiece 11 is arranged in the box 12, a workpiece 11 may be transferred to a device that performs assembly, or a workpiece 11 may be brought into direct contact with another workpiece to be assembled. In this way, a workpiece 11 may be transferred and brought into contact with a workpiece to be assembled to be subjected to assembly, manufacturing an article.

A robot arm 31 is a manipulator and includes a robot hand 40 as an end effector. The robot arm 31 illustrated in FIG. 1 is a vertical articulated robot arm. The robot hand 40 is supported by the robot arm 31. The robot hand 40 is attached to a predetermined portion of the robot arm 31, for example, a distal end portion of the robot arm 31. The robot hand 40 is configured to hold a workpiece 11.

The joints of the robot arm 31 and the finger portions (holding portion) of the robot hand 40 are provided with motors as drive sources for driving each of the joints and each of the finger portions, speed reducers, and encoders as position detection units for detecting rotation angles of the motors. The installation position and the output method of each encoder are not limited. Based on values from these encoders, control commands are output to the respective motors. Then, by each motor being driven, the robot arm 31 is brought into various orientations, the robot hand 40 is positioned at various positions in various orientations, and the finger portions are driven, enabling operation on the workpieces 11 to be executed. A sensor to detect force information may be mounted to each joint of the robot arm 31 and the finger portions (holding portion) of the robot hand 40.

A system control device 20 sends commands to the robot arm 31, the robot hand 40, and other devices to control the entire robot system 1000. The system control device 20 is configured as a computer including a microprocessor. As illustrated in FIG. 1, the computer as the system control device 20 includes a central processing unit (CPU) 20a. The computer further includes a read-only memory (ROM) 20b and a random access memory (RAM) 20c. The computer further includes a communication interface (hereinafter referred to as an I/F) 20d. These components can communicate with each other via bus communication. The CPU 20a, which is a processor, is an example of a control unit.

In the ROM 20b, a program 20e is recorded. The program 20e causes the computer, i.e., the CPU 20a to execute output of commands for controlling the robot arm 31, the robot hand 40, and other devices. The RAM 20c is used to temporarily store a program for controlling the entire robot system 1000, and data, such as execution timings of operation on each control target and control commands. The CPU 20a acquires, for example, data transmitted from an input device 21, a robot control device 30, an image processing device 50, and various sensors, all of which will be described below, by the I/F 20d receiving the data. The CPU 20 a can transmit a command as a control target value to a control device that controls each control target via the I/F 20d based on a program and/or data input from a user. In the present embodiment, a plurality of control devices, such as the robot control device 30 and the image processing device 50, are used, but the present disclosure is not limited thereto. For example, the system control device 20 alone may control the robot arm 31 and the robot hand 40 and acquire data from imaging devices 52, which will be described below. That is, the robot system 1000 may be controlled by at least one control device. In the present embodiment, the communication between the system control device 20, the robot control device 30, and the image processing device 50 is performed through wired communication, but may be performed through wireless communication.

In the present embodiment, the program 20e is recorded in the ROM 20b, but the present disclosure is not limited to this. The program 20e may be recorded on any recording medium as long as the recording medium is a non-transitory recording medium readable by a computer. As a recording medium for supplying the program 20e to the computer, for example, a flexible disk, a hard disk, an optical disk, a magneto-optical disk, a magnetic tape, a nonvolatile memory, and the like can be employed.

Although not illustrated in FIG. 1 for the sake of simplicity of description, the robot control device 30 and the image processing device 50 are also each configured as a computer including a microprocessor, similarly to the system control device 20. The robot control device 30 and the image processing device 50 each include a CPU, a ROM, and a RAM. The robot control device 30 and the image processing device 50 each further include a communication interface. Each CPU, which is a processor, is an example of a control unit.

The robot arm 31 and the robot hand 40 are operated by the robot control device 30 based on commands from the system control device 20. The robot control device 30 is connected to the system control device 20 so as to be communicable with the system control device 20 via wired or wireless communication. The robot control device 30 starts pick-and-place operation on a workpiece 11 in response to a command from the system control device 20, and transmits a notification of the end of the pick-and-place operation to the system control device 20.

The robot control device 30 is communicably connected to each drive unit of the robot arm 31 to control the operation of the robot arm 31 in real time. The CPU of the robot control device 30 executes programs recorded in the ROM, making it possible to execute the operation of the robot arm 31 described above. Further, the ROM of the image processing device 50 can store trajectory data or the like including angle values of each joint, which is necessary for the operation of the robot arm 31.

The robot control device 30 is communicably connected to each drive unit of the robot hand 40 to control the operation of the finger portions (holding unit) mounted on the robot hand 40 in real time. By moving the finger portions toward or away from each other, the finger portions come into contact with a workpiece 11, allowing the finger portions to grip (hold) the workpiece 11. The approach or separation operation of the finger portions are performed by, by way of example, a motor or compressed air.

It is desirable to set a gripping force, a speed, and a stroke in accordance with the properties of the workpiece 11 in numerical control in the case of driving by a motor or in speed control in the case of driving by compressed air. For example, when the workpiece 11 is heavy, the gripping force is increased so that the workpiece 11 will not fall during the conveyance by the robot arm 31 and the robot hand 40. Further, for example, when the workpiece 11 is soft, the force for holding the workpiece 11 is weakened so as not to deform the workpiece 11. The CPU of the robot control device 30 executes programs recorded in the ROM, making it possible to execute the control of each finger portion described above. Further, the ROM of the robot control device 30 can store data or the like including numerical values and speed information necessary for the operation of the finger portions.

The image processing device 50 is communicably connected to at least one imaging device 52 via wired or wireless communication to control each imaging device 52 and process captured images. Each imaging device in the present embodiment is composed of a camera and a lens, but may be further provided with an illumination unit as necessary. The image processing performed by the image processing device 50 includes processing, composition, and matching of two-dimensional images to acquire information about the orientation of a workpiece 11 held by the robot hand 40. The image processing device 50 acquires information about the orientation of a workpiece 11 gripped by the robot hand 40 in response to a command from the system control device 20, and transmits the acquired orientation information to the system control device 20. The CPU of the image processing device 50 executes programs recorded in the ROM, enabling the execution of the above-described image processing. Further, various parameters necessary for the image processing can be stored in the ROM of the image processing device 50. Then, the system control device 20 transmits data for controlling the robot hand 40 to the robot control device 30 based on the acquired orientation information about the workpiece 11. This enables inclination correction on the workpiece 11 by the robot hand 40 and positional correction on the workpiece 11 by the robot arm 31. In the example of FIG. 1, the two imaging devices 52 are arranged: one captures the workpiece 11 from the X direction, and the other captures the workpiece 11 from the Z direction. The number of imaging devices may however be one or three or more as long as the orientation of a workpiece 11 can be detected.

The system control device 20 is connected to the input device 21 for inputting commands by users. A teaching pendant is suitable as the input device 21, but various terminals, such as a smartphone and a tablet, may be employed. The input device 21 illustrated in FIG. 1 will be described by taking, as an example, a tablet-type teaching pendant including a touch panel display as a user interface. The touch panel display of the input device 21 illustrated in FIG. 1 displays “Fully Automatic”, “Automatic”, “Manual”, “Origin”, “Activation”, and “Adjustment” buttons. When a user presses these buttons, the user can issue commands for the robot arm 31 and/or the robot hand 40 to the system control device 20.

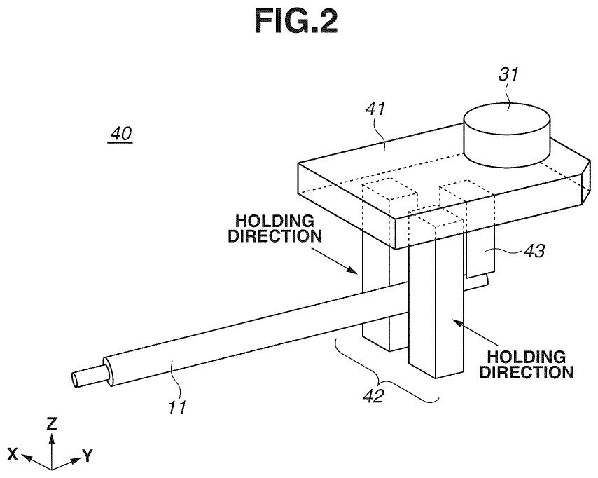

FIG. 2 is a schematic diagram illustrating the robot hand 40 according to the present embodiment. As illustrated in FIG. 2, the robot hand 40 includes a palm portion 41, the holding members 42 that operate to hold a workpiece 11, and a contact member 43 that can contact the workpiece 11 with the workpiece 11 being held by the holding members 42. The holding members 42 may be referred to as first members, and the contact member 43 may be referred to as a second member. In the case of holding the workpiece 11 in the vicinity of an end of the workpiece 11 away from the center of gravity as illustrated in FIG. 2, if the holding force that can be output by the holding members 42 cannot withstand an orientation change of the workpiece 11 due to its own weight, the workpiece 11 is inclined in the direction of gravity due to its own weight, changing the orientation of the workpiece 11. To address this, the robot hand 40 according to the present embodiment is configured to change relative positions between the holding members 42 and the contact member 43 with a workpiece 11 being held by the holding members 42. As illustrated in FIG. 2, when the workpiece 11 is held by the holding members 42 relative to the Y direction, the holding members 42 are disposed between the center of gravity of the workpiece 11 and the contact member 43.

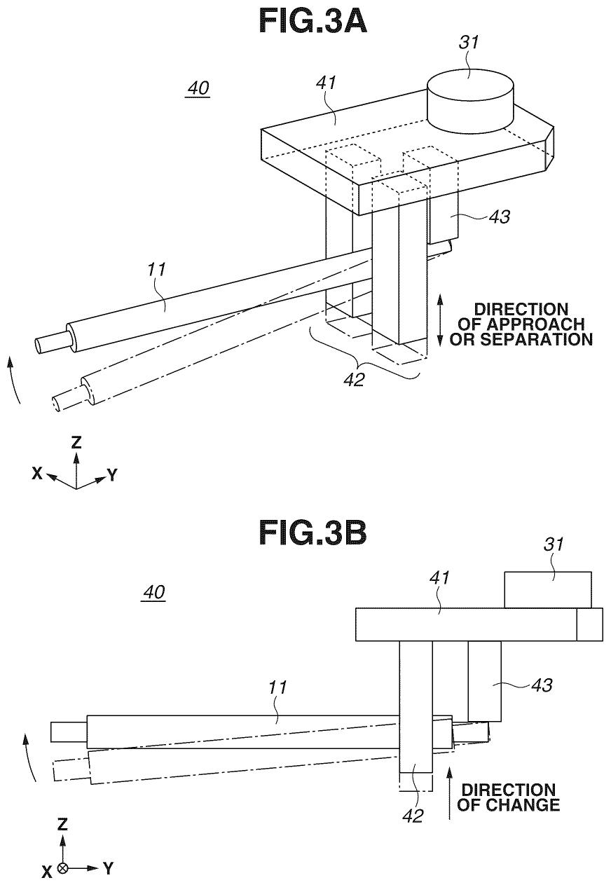

FIGS. 3A and 3B are schematic diagrams illustrating an operation for changing the orientation of a workpiece 11 by the robot hand 40 in the present embodiment. FIG. 3A is a perspective view and FIG. 3B is a side view thereof. As illustrated in FIGS. 3A and 3B, the contact member 43 is fixed to the palm portion 41, and the holding members 42 are further able to be shifted relative to the palm portion 41 in a direction in which the holding members 42 approach or separate from the contact member 43. By bringing the holding members 42 close to the contact member 43 with the workpiece 11 being held by the holding members 42, the orientation of the workpiece 11 can be changed with the contact point between the contact member 43 and the workpiece 11 as a fulcrum, allowing the orientation of the workpiece 11 to be corrected. Furthermore, the holding members 42 are moved in the direction opposite to the direction of gravity of the workpiece 11, changing the orientation of the workpiece 11. In addition, the holding members 42 hold the workpiece 11 in the vicinity of its end away from its center of gravity, imparting a certain degree of reproducibility of an inclination of the orientation of the workpiece 11. The contact member 43 is positioned on the side opposite to the side where the orientation of the workpiece 11 is inclined.

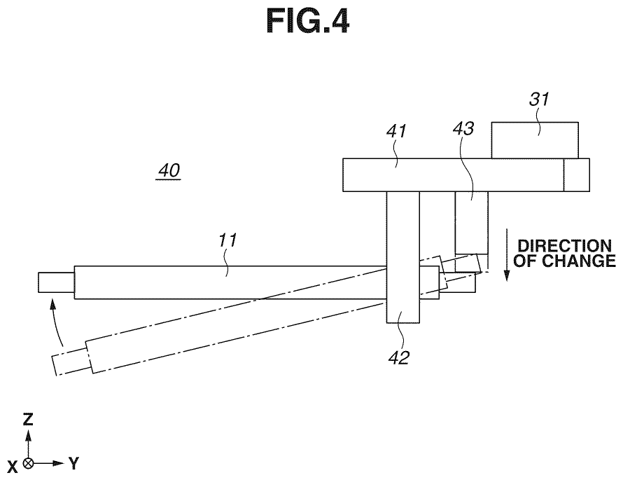

As illustrated in FIG. 4, the contact member 43 may be brought close to the holding members 42. FIG. 4 is a schematic diagram illustrating a modification of the operation for changing the orientation of a workpiece 11 by the robot hand 40 in the present embodiment. In FIG. 4, the holding members 42 are fixed to the palm portion 41 so as to be prevented from approaching the contact member 43, and have a function of causing the contact member 43 to approach the holding members 42. Bringing the contact member 43 close to the holding members 42 with the workpiece 11 being held by the holding members 42 makes it possible for the orientation of the workpiece 11 to be changed with the contact point between the contact member 43 and the workpiece 11 as a fulcrum, enabling the orientation of the workpiece 11 to be corrected. More specifically, the contact member 43 is moved in the direction of gravity of the workpiece 11, changing the orientation of the workpiece 11. In the example illustrated in FIGS. 3 and 4, either the holding members 42 or the contact member 43 has the function of approaching the other; however, both the holding members 42 and the contact member 43 may have a function of approaching each other. As described above, it is sufficient to make either the holding members 42 or the contact member 43 closer to the other.

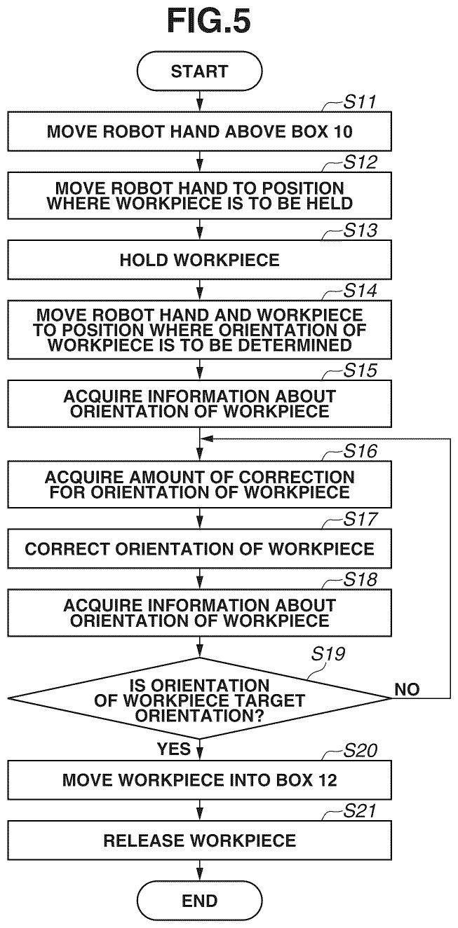

FIG. 5 is a flowchart executed to perform an operation on the workpiece 11 in the embodiment. The control flow illustrated in FIG. 5 is executed by the CPUs of the control devices operating in cooperation with each other through communication.

In FIG. 5, first, in step S11, the system control device 20 sends a command to the robot control device 30 to cause the robot control device 30 to operate the robot arm 31 so that the robot arm 31 moves the robot hand 40 above the box 10. It is desirable to acquire information about the orientation of the robot arm 31 before operating the robot hand 40, and then to move the robot arm 31 via a via point or via points provided depending on the situation so as to prevent interference with the boxes 12 and 10.

Next, in step S12, the robot control device 30 moves the robot hand 40 to a position where a workpiece 11 placed in the box 10 is to be held. It is on the premise that there are positions corresponding to a plurality of workpieces 11 to be placed, in the box 10. It is desirable for the robot arm 31 to have the number of teaching points for holding positions corresponding to the number of positions where workpieces 11 are to be placed, and for a via point or via points to be provided as appropriate so as for the robot hand 40 to be prevented from interfering with the box 10 or the other workpieces 11 when moving from a position above the box 10 to a holding position.

Next, in step S13, the robot control device 30 moves the holding members 42 of the robot hand 40 in the direction of holding the workpiece 11 so that the holding members 42 hold the workpiece 11.

Next, in step S14, the robot control device 30 uses the robot arm 31 to move the robot hand 40 and the workpiece 11 to a position where the orientation of the workpiece 11 held by the robot hand 40 can be determined by the imaging devices 52. After the workpiece 11 is moved, the robot control device 30 transmits information indicating the completion of the movement of the workpiece 11 to the system control device 20.

Next, in step S15, after receiving the information indicating the completion of the movement of the workpiece 11, the system control device 20 transmits a command to execute the determination of the orientation of the workpiece 11 to the image processing device 50.

The image processing device 50 acquires information about the orientation of the workpiece 11 acquired from the imaging devices 52.

Then, in step S16, the amount of correction relating to the orientation of the workpiece 11 is acquired based on a reference image showing a target orientation of the workpiece 11 and the acquired image showing the current orientation of the workpiece 11 acquired in step S15. The amount of correction is acquired as an amount of movement of the holding members 42 or the contact member 43. The acquired information about the amount of movement of the holding members 42 and/or the contact member 43 is transmitted to the system control device 20.

Next, in step S17, the system control device 20 transmits the amount of movement transmitted from the image processing device 50 to the robot control device 30, and also transmits a command to change the orientation of the workpiece 11 to the robot control device 30. The robot control device 30 moves the holding members 42 and/or the contact member 43 based on the amount of movement transmitted from the system control device 20 to bring the holding members 42 and/or the contact member 43 into contact with the workpiece 11 to change and correct the orientation of the workpiece 11. Then, the robot control device 30 transmits information indicating that the movement of the holding members 42 and/or the contact member 43 is completed, to the system control device 20.

Next, in step S18, after receiving the information indicating the completion of the movement of the holding members 42 and/or the contact member 43, the system control device 20 transmits a command to execute the determination of the orientation of the workpiece 11 to the image processing device 50. The image processing device 50 acquires information about the orientation of the workpiece 11 acquired from the imaging devices 52.

Next, in step S19, the image processing device 50 determines whether the orientation of the workpiece 11 is the target orientation based on the reference image showing the target orientation of the workpiece 11 and the acquired image showing the current orientation of the workpiece 11 acquired in step S18. In the determination, a tolerance range is set for the difference between the current orientation and the target orientation of the workpiece 11. If the difference between the current orientation and the target orientation of the workpiece 11 is out of the tolerance range (NO in step S19), the process returns to step S16. The amount(s) of movement of the holding members 42 and/or the contact member 43 for correcting the orientation of the workpiece 11 are or is acquired, and the correction of the orientation of the workpiece 11 is repeated again. If the difference between the current orientation and the target orientation of the workpiece 11 is within the tolerance range (YES in step S19), information indicating that the current orientation of the workpiece 11 has been determined to be the target orientation is transmitted to the system control device 20, and the process proceeds to step S20. If it is determined that the current orientation is out of a range indicating that the orientation is correctable due to a significantly large inclination of the orientation of the workpiece 11, the state may be determined to be an anomaly, causing the subsequent operation to be stopped.

Next, in step S20, after the system control device 20 receives the information indicating that the current orientation of the workpiece 11 has been determined to be the target orientation, the system control device 20 transmits, to the robot control device 30, a command to move the workpiece 11 into the box 12. The robot control device 30 operates the robot arm 31 so that the robot arm 31 moves the workpiece 11 being held to the box 12. The position where the workpiece 11 is to be placed is changed according to the type of the workpiece 11, the number of times of taking out workpieces 11, and the like with a partition or partitions provided in the box 12. It is desirable to provide a via point or via points as appropriate to prevent interference with the box 10 and 12 when the workpiece 11 is moved.

Then, in step S21, the robot control device 30 operates the holding members 42 of the robot hand 40 so that the holding members 42 release and place the workpiece 11 in the box 12. Then, the robot control device 30 transmits information indicating that the workpiece 11 has been placed in the box 12 to the system control device 20, and the control flow ends.

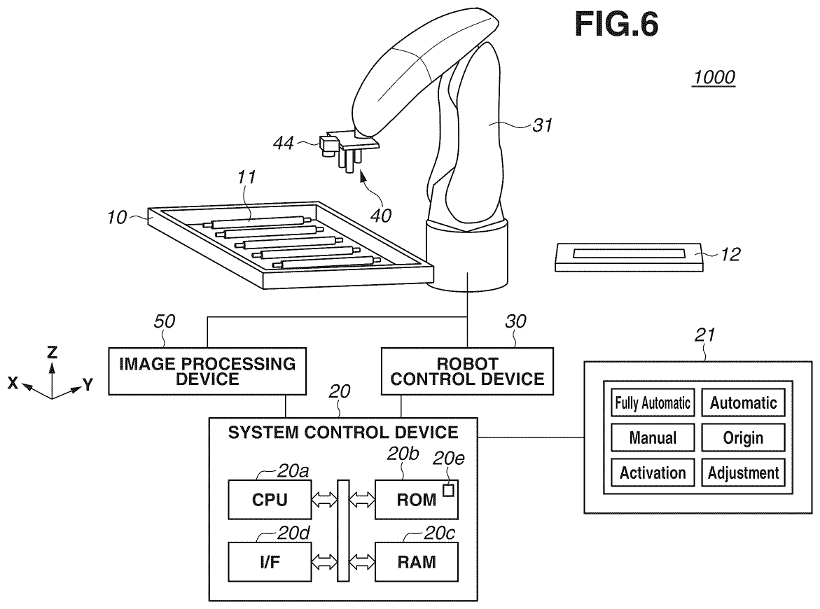

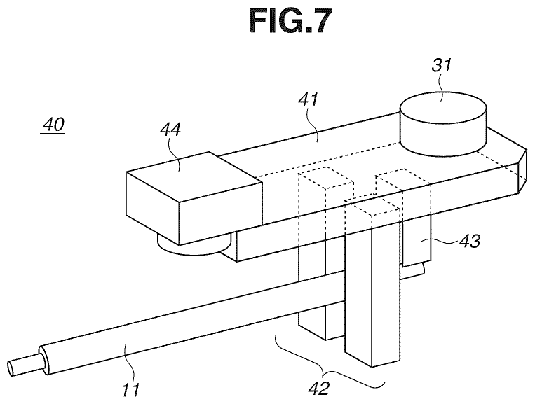

FIG. 6 is a schematic diagram illustrating a modification example of the robot system 1000 of the present embodiment. FIG. 7 is a schematic diagram illustrating a modification of the robot hand 40 of the present embodiment. The robot hand 40 illustrated in FIGS. 6 and 7 includes an imaging device 44 in addition to the palm portion 41, the holding members 42, and the contact member 43. The imaging device 44 generally includes a camera, a lens, and an illumination unit. The imaging device 44 is connected to the image processing device 50 via wiring inside the robot arm 31, and the image processing device 50 controls the imaging device 44 and processes images captured by the imaging device 44. As illustrated in FIG. 7, the imaging device 44 is disposed so as to acquire information about the orientation of a workpiece 11 from the palm portion 41. Examples of image processing performed by the image processing device 50 include position determination of a placement geometry of the box 10 and the box 12 and position determination of the workpiece 11. Further, the examples also include processing and composition of images for improving determination accuracy. In this way, information about the orientation of the workpiece 11 may be acquired by an on-hand camera.

According to the present embodiment, the relative position between the holding members 42 and the contact member 43 can be changed with a workpiece 11 being held by the holding members 42. Even when the end of the workpiece 11 is held in such a manner that the orientation of the workpiece 11 is changed by its own weight, this allows the orientation of the workpiece 11 to be corrected by the holding members 42 and/or the contact member 43 to maintain the orientation of the workpiece 11 in a predetermined state. Thus, it is possible to execute an operation in which the holding position on a workpiece 11 is determined and the orientation of the workpiece 11 is required to be maintained in a predetermined state, such as placing the workpiece 11 in the box 12 that includes a nest for the workpiece 11 or inserting the workpiece 11 into another workpiece. Further, this correction can be performed while reducing the possibility of the holding members 42 interfering with the box 12 or another workpiece.

### Second Embodiment

A second embodiment will now be described in detail. In the following description, the same reference numerals are used for the same or corresponding components as those in the first embodiment, the description thereof will be omitted or simplified, and the description will be given with a focus on difference from the first embodiment.

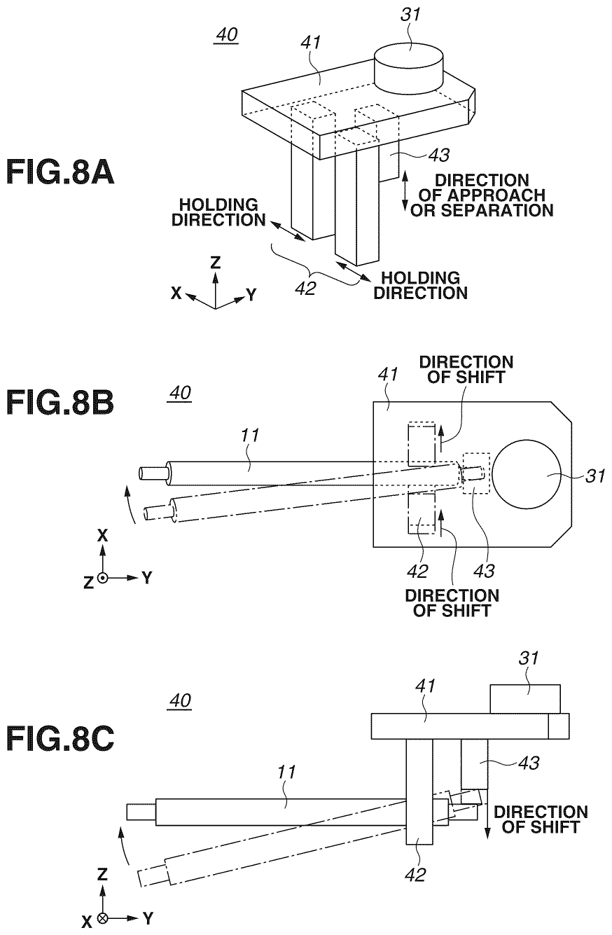

FIGS. 8A to 8C are schematic diagrams illustrating the robot hand 40 in the present embodiment. FIG. 8A is a perspective diagram illustrating the robot hand 40, FIG. 8B is an XY plane view (top view) of the robot hand 40 in a state of holding the workpiece 11, and FIG. 8C is a YZ plane view (side view) of the robot hand 40 in a state of holding the workpiece 11.

As illustrated in FIG. 8A, the holding members 42 have a function of shifting a workpiece 11 in directions (holding direction) in which the holding members 42 move when the workpiece 11 is to be held. This may also serve as a function of moving the holding members 42 to hold a workpiece 11. That is, the holding members 42 are provided on the palm portion 41 so as to approach or separate from each other independently. The contact member 43 has a function of approaching the holding members 42.

As illustrated in FIG. 8B, when the orientation of a workpiece 11 is inclined in the XY plane, each of the holding members 42 is shifted in the +X direction. If the orientation of the workpiece 11 cannot be sufficiently corrected only by shifting each of the holding members 42 in one direction, each of the holding members 42 may be moved in the Y direction. With the workpiece 11 being held at a position where the holding members 42 is shifted in the Y direction by any of the holding members 42 being shifted in the Y direction, any of the holding members 42 may be shifted in an X direction from this state. When the orientation of the workpiece 11 is inclined in the YZ plane, the contact member 43 is shifted. The combination of these operations makes it possible to correct an inclination of the orientation of a workpiece 11 in each of the XY plane and the YZ plane.

According to the present embodiment, the relative position between the holding members 42 and the contact member 43 can be changed with a workpiece 11 held by the holding members 42. Even when the end of a workpiece 11 is held in such a manner that the orientation of the workpiece 11 is changed by its own weight, this allows the orientation of the workpiece 11 to be corrected by the holding members 42 and/or the contact member 43 to maintain the orientation of the workpiece 11 in a predetermined state. Thus, it is possible to execute an operation in which the holding position on a workpiece 11 is determined and the orientation of the workpiece 11 is required to be maintained in a predetermined state, such as placing the workpiece 11 in the box 12 that includes a nest for the workpiece 11 or inserting the workpiece 11 into another workpiece. Further, this correction can be performed while reducing the possibility of the holding members 42 interfering with the box 12 or another workpiece. Further, the orientation of a workpiece 11 on a different plane can be corrected, which provides increased accuracy of the holding orientation of a workpiece 11. In the present embodiment, the example has been described where the contact member 43 is brought close to the holding members 42, but the present disclosure is not limited thereto. The holding members 42 may be brought close to the contact member 43, or the holding members 42 and the contact member 43 may be brought close to each other. The above-described various embodiments and modifications may be combined.

### Third Embodiment

A third embodiment will now be described in detail. In the following description, the same reference numerals are used for the same or corresponding components as those of the above-described various embodiments, the description thereof will be omitted or simplified, and the description will be given with a focus on difference from the above-described various embodiments. In the present embodiment, a restraining portion is provided that restrains shift of contact positions between the holding members 42, a workpiece 11, and the contact member 43 in correction of the orientation of the workpiece 11.

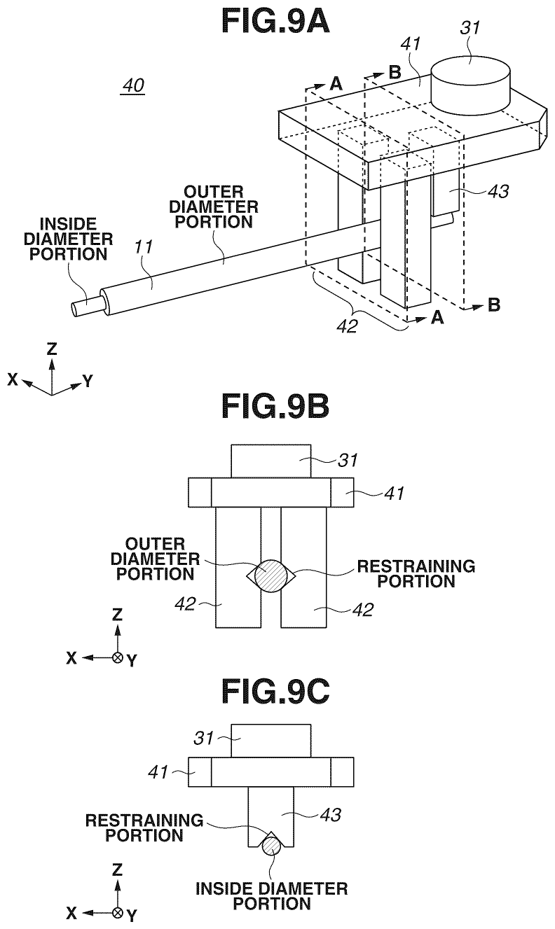

FIGS. 9A to 9C are schematic diagrams illustrating the robot hand 40 in the present embodiment. FIG. 9A is a perspective view illustrating the robot hand 40 in a state of holding the workpiece 11. FIG. 9B is a cross-sectional diagram taken along a line A-A illustrating the robot hand 40 in a state of holding the workpiece 11, and FIG. 9C is a cross-sectional diagram taken along a line B-B illustrating the robot hand 40 in a state of holding the workpiece 11.

As illustrated in FIG. 9B, each of the holding members 42 on the robot hand 40 of the present embodiment has a V-shaped groove penetrating in the Y direction as a restraining portion. An outer diameter portion of a workpiece 11 is held by the restraining portions in the holding members 42. In FIG. 9B, a restraining portion is provided in each of the holding members 42, but may be provided in one of the holding members 42. Further, as illustrated in FIG. 9C, the contact member 43 on the robot hand 40 of the present embodiment has a V-shaped groove penetrating in the Y direction as a restraining portion. The restraining portion in the contact member 43 is brought into contact with an inside diameter portion of the workpiece 11.

This makes it possible to reduce the deviation of the holding position on the workpiece 11. In addition, this allows the position of the workpiece 11 to be uniquely determined with respect to the holding members 42 or the contact member 43 when the workpiece 11 is held.

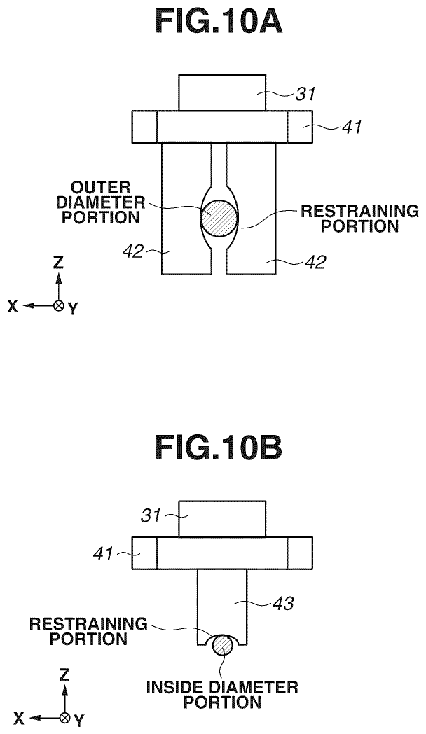

FIGS. 10A and 10B are diagrams illustrating a modification of the restraining portions in the present embodiment. FIG. 10A is a cross-sectional diagram illustrating the robot hand 40 in a state of holding the workpiece 11, taken along the line A-A in the same direction as in FIG. 9A, and FIG. 10B is a cross-sectional diagram illustrating the robot hand 40 in a state of holding the workpiece 11, taken along the line B-B in the same direction as in FIG. 9A.

As illustrated in FIG. 10A, each of the holding members 42 on the robot hand 40 of the present embodiment, has an arc-shaped groove penetrating in the Y direction as a restraining portion. The outer diameter portion of a workpiece 11 is held by the restraining portions in the holding members 42. In FIG. 10A, a restraining portion is provided in each of the holding members 42, but may be provided in one of the holding members 42. Further, as illustrated in FIG. 10B, the contact member 43 on the robot hand 40 of the present embodiment has an arc-shaped groove penetrating in the Y direction as a restraining portion. The restraining portion in the contact member 43 is brought into contact with the inside diameter portion of a workpiece 11. This makes it possible to reduce the deviation of the holding position on the workpiece 11. In addition, this allows the position on the workpiece 11 to be uniquely determined with respect to the holding members 42 or the contact member 43 when the workpiece 11 is held.

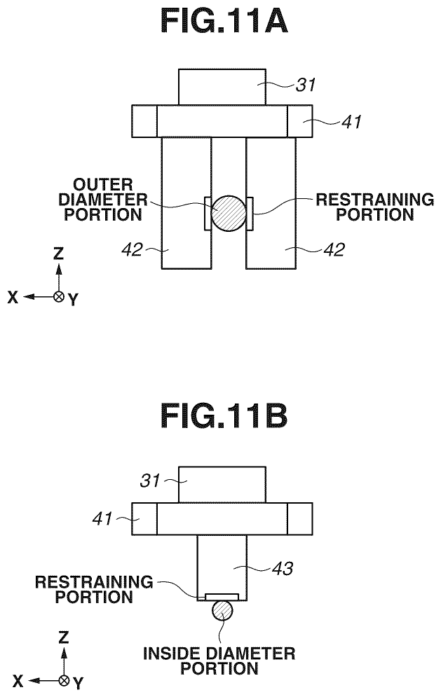

FIGS. 11A and 11B are diagrams illustrating a modification of the restraining portions in the present embodiment. FIG. 11A is a cross-sectional diagram illustrating the robot hand 40 in a state of holding the workpiece 11, taken along the line A-A in the same direction as FIG. 9A, and FIG. 11B is a cross-sectional diagram illustrating the robot hand 40 in a state of holding the workpiece 11, taken along the line B-B in the same direction as FIG. 9A.

As illustrated in FIG. 11A, the holding members 42 on the robot hand 40 of the present embodiment each include a frictional member as a restraining portion at a portion where the friction member comes into contact with the outer diameter portion of a workpiece 11. The outer diameter portion of the workpiece 11 is held by the restraining portions of the holding members 42. In FIG. 11A, a restraining portion is provided on each of the holding members 42, but may be provided on one of the holding members 42. As illustrated in FIG. 11B, the contact member 43 on the robot hand 40 of the present embodiment includes a frictional member as a restraining portion at a portion where the friction member comes into contact with the inside diameter portion. The restraining portion on the contact member 43 is brought into contact with the inside diameter portion of the workpiece 11. The friction member is, for example, urethane rubber, which is made of a polymer compound, such as silicone resin. Without concern for surface scratches on the workpiece 11, the entire surface or a part of each holding member 42 may be roughened by cutting, shot blasting, or the like. According to the present embodiment, the friction coefficient between a workpiece 11, the holding members 42, and/or the contact member 43 can be increased as compared with a case where the friction member is not added, allowing the deviation of the holding position on the workpiece 11 to be reduced. In addition, this allows the position on the workpiece 11 to be uniquely determined with respect to the holding members 42 or the contact member 43 when the workpiece 11 is held.

According to the present embodiment, the relative position between the holding members 42 and the contact member 43 can be changed with a workpiece 11 being held by the holding members 42. Even when the end of the workpiece 11 is held in such a manner that the orientation of the workpiece 11 is changed by its own weight, this allows the orientation of the workpiece 11 to be corrected by the holding members 42 and/or the contact member 43 to maintain the orientation of the workpiece 11 in a predetermined state. Thus, it is possible to execute an operation in which the holding position on a workpiece 11 is determined and the orientation of the workpiece 11 is required to be maintained in a predetermined state, such as placing the workpiece 11 in the box 12 that includes a nest for the workpiece 11 or inserting the workpiece 11 into another workpiece. Further, this correction can be performed while reducing the possibility of the holding members 42 interfering with the box 12 or another workpiece. Further, the restraining portions allow the position on the workpiece 11 to be uniquely determined with respect to the holding members 42 or the contact member 43 when the workpiece 11 is held, providing increased accuracy of inclination correction of the orientation of a workpiece 11. Further, as a restraining portion, a combination of at least two of the V-groove, the arc-shaped groove, and the friction member may be employed.

### Fourth Embodiment

A fourth embodiment will now be described in detail. In the following description, the same reference numerals are used for the same or corresponding components as those of the above-described various embodiments, the description thereof will be omitted or simplified, and the description will be given with a focus on difference from the above-described various embodiments.

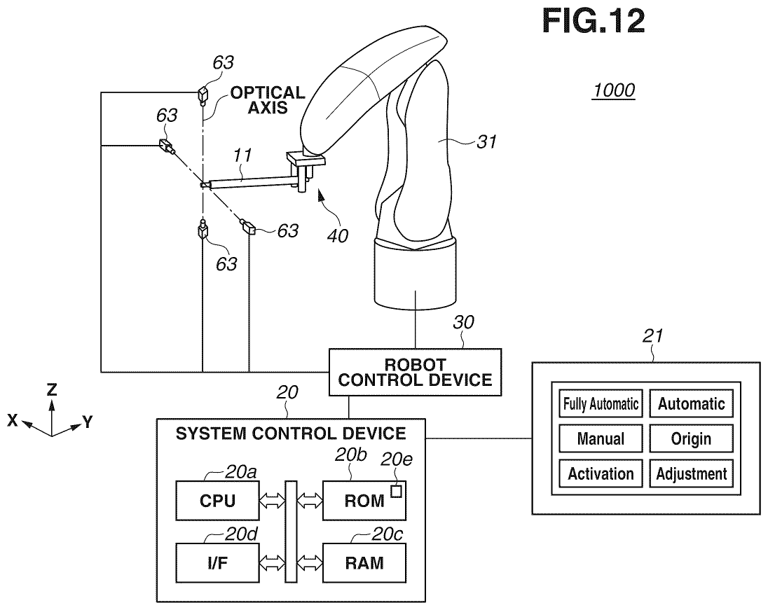

FIG. 12 is a schematic diagram illustrating a robot system 1000 according to the present embodiment. In FIG. 12, for convenience of description, the boxes 10 and 12 are not illustrated. As illustrated in FIG. 12, in the present embodiment, information about the orientation of the workpiece 11 is acquired by one or more sensors 63. Here, the sensors 63 are each illustrated as an image of a through-beam photoelectric sensor as an example of an optical sensor, but are not limited to a through-beam type or are not limited to a photoelectric type. The robot control device 30 acquires information from the sensors 63. In the present embodiment, information from the sensors 63 is acquired by the robot control device 30, but a sensor control device configured as a computer including a microprocessor may be separately provided, similarly to the system control device 20.

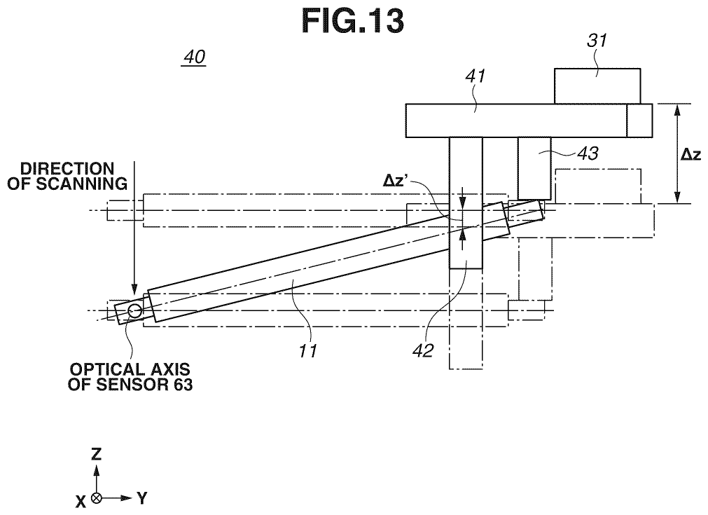

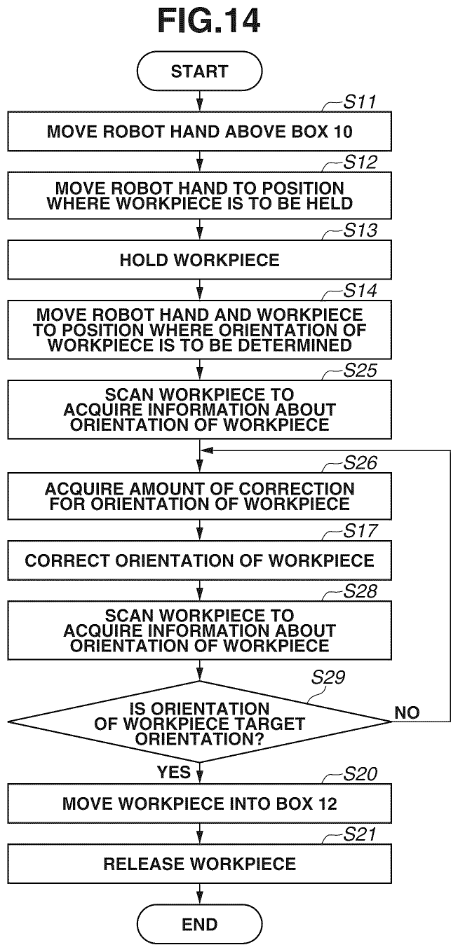

FIG. 13 is a diagram for describing correction of the orientation of a workpiece 11 in the present embodiment. FIG. 14 is a control flowchart executed when the orientation of a workpiece 11 is corrected in the present embodiment. The control flow illustrated in FIG. 14 is executed by the CPUs of the control devices in cooperation with each other through communication. As illustrated in FIG. 14, in the present embodiment, in order to acquire information about the orientation of the workpiece 11, steps S25 and S26 and steps S28 and S29 are executed instead of steps S15 and S16 and steps S18 and S19.

In FIGS. 13 and 14, first, in step S25, the system control device 20 transmits a command to execute acquisition of information about the orientation of the workpiece 11, to the robot control device 30. The robot control device 30 then operates the robot arm 31 so that the robot arm 31 scans the workpiece 11 so as for an end portion of the workpiece 11 to block the optical axis of the sensor(s) 63 with the workpiece 11 being held by the robot hand 40. Then, information about the position and/or the orientation of the robot hand 40 at the timing when the sensor 53 detects the end portion of the workpiece 11 is acquired from an encoder or the like mounted on the robot arm 31.

In step S26, the robot control device 30 obtains a difference Δz between the information about the position and/or the orientation of the robot hand 40 that are acquired and information about the position and/or the orientation of the robot hand 40 that will be acquired based on the sensor(s) 63 if it can be determined that the orientation of the workpiece 11 is not inclined.

This makes it possible to geometrically estimate the orientation of a workpiece 11. The orientation of the workpiece 11 can be corrected by calculating the amount of movement Δz′ by which the holding members 42 and/or the contact member 43 are or is shifted based on an estimated value.

Then, in step S17, the orientation of the workpiece 11 is corrected based on the amount of movement Δz′. Then, in step S28 again, the robot control device 30 causes the workpiece 11 to be scanned so that the end portion of the workpiece 11 blocks the optical axis of the sensor 53 with the workpiece 11 being held by the robot hand 40 to acquire information about the orientation of the workpiece 11. Then, in step 29, it is determined whether the position and/or orientation of the robot hand 40 that are or is acquired can be determined to be the position and/or orientation of the robot hand 40 that are or is a target or targets. This determination is made by setting a tolerance range or tolerance ranges for the position and/or the orientation of the robot hand 40 that will be acquired based on the sensor(s) 63 in a case where it can be determined that the orientation of the workpiece 11 is not inclined. If the position and/or the orientation of the robot hand 40 are or is within the tolerance range(s) (YES in step S29), the process proceeds to step S20. If the position and/or the orientation of the robot hand 40 are or is out of the tolerance range(s) (NO in step S29), the process returns to step S26, and the correction operation on the orientation of the workpiece 11 is repeated.

According to the present embodiment, the relative position between the holding members 42 and the contact member 43 can be changed with a workpiece 11 being held by the holding members 42. Even when the end of the workpiece 11 is held in such a manner that the orientation of the workpiece 11 is changed by its own weight, this allows the orientation of the workpiece 11 to be corrected by the holding members 42 and/or the contact member 43 to maintain the orientation of the workpiece 11 in a predetermined state. Thus, it is possible to execute an operation in which the holding position on a workpiece 11 is determined and the orientation of the workpiece 11 is required to be maintained in a predetermined state, such as placing the workpiece 11 in the box 12 that includes a nest for the workpiece 11 or inserting the workpiece 11 into another workpiece. Further, this correction can be performed while reducing the possibility of the holding members 42 interfering with the box 12 or another workpiece. Further, the orientation of the workpiece 11 can be corrected at low cost as compared with the case of using an imaging device.

In the present embodiment, the amount of correction for correcting the orientation of the workpiece 11 is calculated using the sensor(s) 63, but the present disclosure is not limited thereto. For example, information about the inclination of the orientation of the workpiece 11 may be acquired based on information acquired from a force sensor or force sensors or the like included in the holding members 42 and geometry information with the workpiece 11. Alternatively, information about the inclination of the orientation of the workpiece 11 may be acquired based on information acquired from a slip sensor or slip sensors or the like included in the holding members 42 and geometry information with the workpiece 11.

### Fifth Embodiment

A fifth embodiment will now be described in detail. In the following description, the same reference numerals are used for the same or corresponding components as those of the above-described various embodiments, the description thereof will be omitted or simplified, and the description will be given with a focus on difference from the above-described various embodiments. A workpiece 11 handled by the robot system 1000 has a known geometry, and it can be considered that the orientation of the workpiece 11 when gripped by the robot hand 40 has a certain degree of reproducibility. For that reason, even if there is no method for determining the orientation of the workpiece 11, the orientation of the workpiece 11 may be corrected by the holding members 42 and/or the contact member 43 being shifted by a preset amount or preset amounts.

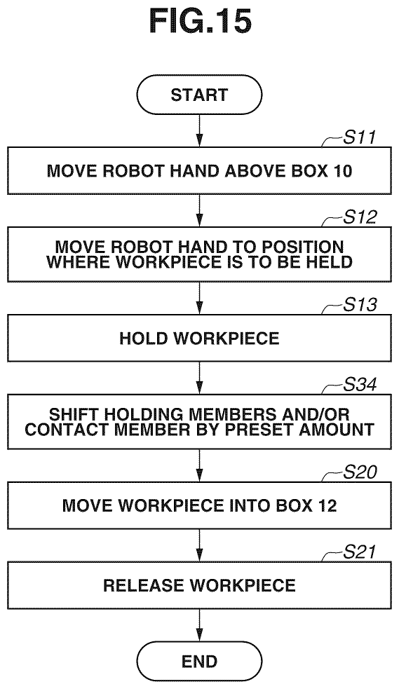

FIG. 15 is a flowchart executed to perform an operation on a workpiece 11 in the present embodiment. The control flow illustrated in FIG. 15 is executed by the CPUs of the control devices in cooperation with each other through communication.

In FIG. 15, first, in step S11, the system control device 20 transmits a command to the robot control device 30 to cause the robot control device 30 to operate the robot arm 31 so that the robot arm 31 moves the robot hand 40 above the box 10. It is desirable to acquire information about the orientation of the robot arm 31 before operating the robot hand 40, and then to move the robot arm 31 via a via point or via points provided depending on the situation so as to prevent interference with the boxes 12 and 10.

Next, in step S12, the robot control device 30 moves the robot hand 40 to a position where a workpiece 11 placed in the box 10 is to be held. It is on the premise that there are places where a plurality of workpieces 11 are to be placed in the box 10. It is desirable for the robot arm 31 to have the number of teaching points for holding positions corresponding to the number of positions where the workpieces 11 are to be placed, and for a via point or via points to be provided as appropriate so as for the robot hand 40 to be prevented from interfering with the box 10 or other workpieces 11 when moving from a position above the box 10 to a holding position.

Next, in step S13, the robot control device 30 moves the holding members 42 of the robot hand 40 in the holding direction of the workpiece 11 to hold the workpiece 11.

Next, in step S34, the holding members 42 and/or the contact member 43 are or is then shifted by a preset amount or preset amounts. The amount(s) of movement (the amount(s) of shift) to be set may be experimentally set based on an average of amounts of inclinations obtained by the robot hand 40 holding actual workpieces 11 a plurality of times. Alternatively, the amount(s) of movement may be set using a simulator that executes a physical simulation. In this way, the inclination of the orientation of a workpiece 11 is corrected. The robot control device 30 transmits information indicating that the correction of the orientation of the workpiece 11 is completed, to the system control device 20.

Next, in step S20, the system control device 20 sends a command to cause the robot control device 30 to move the workpiece 11 into the box 12, to the robot control device 30. The robot control device 30 operates the robot arm 31 so that the robot arm 31 moves the held workpiece 11 into the box 12. The position where a workpiece 11 is to be placed is changed according to the type of the workpiece 11, the number of times of taking out workpieces 11, and the like with a partition or partitions in the box 12. It is desirable to provide a via point or via points as appropriate to prevent interference with the box 10 and 12 when the workpiece 11 is moved.

Then, in step S21, the robot control device 30 operates the holding members 42 of the robot hand 40 so that the holding members 42 release and place the workpiece 11 in the box 12. Then, the robot control device 30 transmits information indicating that the workpiece 11 has been placed in the box 12 to the system control device 20, and the control flow ends.

According to the present embodiment, the relative position between the holding members 42 and the contact member 43 can be changed with a workpiece 11 being held by the holding members 42. Even when the end of the workpiece 11 is held in such a manner that the orientation of the workpiece 11 is changed by its own weight, this allows the orientation of the workpiece 11 to be corrected by the holding members 42 and/or the contact member 43 to maintain the orientation of the workpiece 11 in a predetermined state. Thus, it is possible to execute an operation in which the holding position on a workpiece 11 is determined and the orientation of the workpiece 11 is required to be maintained in a predetermined state, such as placing the workpiece 11 in the box 12 that includes a nest for the workpiece 11 or inserting the workpiece 11 into another workpiece. Further, this correction can be performed while reducing the possibility of the holding members 42 interfering with the box 12 or another workpiece. Further, the configuration with no mechanism for acquiring the orientation of a workpiece 11 provided therein allows correction of the orientation of the workpiece 11 at low cost. In the present embodiment, the holding members 42 and/or the contact member 43 is or are shifted with a workpiece 11 being held by the box 10. However, the holding members 42 and/or the contact member 43 may be moved to a predetermined position or predetermined positions before the robot hand 40 enters the box 10 as long as there is no possibility of the workpiece 11, the box 10, and/or the robot hand 40 interfering each other when the robot hand 40 enters the box 10. Further, the holding members 42 and/or the contact member 43 may be moved to a predetermined position or predetermined positions in advance at the timing when it is determined that the workpiece 11 is to be taken out.

### Other Embodiments

The processing procedures of the embodiments described above are specifically executed by each CPU of each control device. For that reason, the processing procedures can be configured to read and execute a control program recorded in a recording medium, the control program being software executing the above-described functions. In this case, the control program itself read from the recording medium implements the functions of the above-described embodiments; therefore, the control program itself and the recording medium recording the control program are included in the present disclosure.

In each embodiment, the case has been described in which the computer-readable recording medium is each ROM, each RAM, or each flash ROM, and the program is stored in the ROM, the RAM, or the flash ROM. However, the present disclosure is not limited to such a configuration. The program for implementing the present disclosure may be recorded in any recording medium, such as a solid state drive (SSD), as long as the recording medium is a computer-readable recording medium. The present disclosure may be implemented by an imaging device having the functions of the image processing device 50.

In the various embodiments described above, the case has been described where the robot arm 31 is an articulated robotic arm having a plurality of joints; however, the number of joints is not limited thereto. While the vertical multi-axis configuration has been described as the form of the robot arm 31, a configuration equivalent to the above-described configuration can be implemented in a different form of joint structure, such as a horizontally articulated type, a parallel link type, or a Cartesian robot.

The various embodiments described above are applicable to a machine that can automatically perform an operation of extension/contraction, bending/stretching, vertical movement, horizontal movement, or turning, or a combined operation thereof, based on information in a storage device provided in a control device.

The present disclosure is not limited to the above-described embodiments, and many modifications can be made within the technical idea of the present disclosure. The effects described in the embodiments of the present disclosure are merely most desired ones produced from the present disclosure, and the effects of the present disclosure are not limited to those described in the embodiments of the present disclosure. The above-described various embodiments and modifications may be combined.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-179624, filed Oct. 15, 2024, which is hereby incorporated by reference herein in its entirety.

What is claimed is:

1. A robot hand that holds a workpiece, the robot hand comprising:
at least one first member configured to hold the workpiece; and
a second member configured to contact the workpiece in a state where the workpiece is held by the at least one first member,
wherein, in a state where the workpiece is held by the at least one first member, an orientation of the workpiece is changed by the at least one first member or the second member being shifted.

2. The robot hand according to claim 1, wherein the orientation of the workpiece is changed by the at least one first member or the second member being shifted based on acquisition of information relating to the orientation of the workpiece, the information being acquired.

3. The robot hand according to claim 2, wherein the information relating to the orientation of the workpiece is acquired by at least one of an imaging device, an optical sensor, a force sensor, and a slip sensor.

4. The robot hand according to claim 1, wherein the orientation of the workpiece is changed by the at least one first member or the second member being shifted based on an amount of shift set to correct the orientation of the workpiece in a state where the workpiece is held by the at least one first member.

5. The robot hand according to claim 1, wherein after the at least one first member or the second member is shifted before the workpiece is held, the workpiece is held in a state where the at least one first member or the second member remains shifted.

6. The robot hand according to claim 1, wherein the at least one first member or the second member is provided with a restraining portion configured to restrain the workpiece.

7. The robot hand according to claim 6, wherein the restraining portion is at least one of a V-shaped groove, an arc-shaped groove, and a friction member.

8. The robot hand according to claim 6, wherein the restraining portion in the at least one first member contacts an outer diameter portion of the workpiece, and the restraining portion in the second member contacts an inside diameter portion of the workpiece.

9. The robot hand according to claim 1, wherein the at least one first member holding the workpiece at a position away from a center of gravity of the workpiece causes an inclination of the orientation of the workpiece to be reproducible.

10. The robot hand according to claim 1, wherein the second member is positioned opposite to a side on which the orientation of the workpiece is inclined.

11. The robot hand according to claim 1,
wherein the at least one first member comprises at least two of the first members,
wherein the at least two first members are configured to independently approach one another or separate from one another, and
wherein by at least one of the at least two first members being shifted, the orientation of the workpiece is changed.

12. The robot hand according to claim 1, wherein, in a case where the workpiece is brought into contact with another workpiece, the at least one first member and the other workpiece interfere with each other depending on a holding position on the workpiece by the at least one first member.

13. The robot hand according to claim 1, wherein the orientation of the workpiece is changed by approach of the at least one first member toward the second member, or approach of the second member toward the at least one first member.

14. The robot hand according to claim 1, wherein the orientation of the workpiece is changed by the at least one first member being moved in a direction opposite to a direction of gravity of the workpiece, or the second member being moved in the direction of gravity of the workpiece.

15. The robot hand according to claim 1, wherein in a case where the at least one first member holds the workpiece, the at least one first member is arranged between a center of gravity of the workpiece and the second member.

16. The robot hand according to claim 1, wherein the at least one first member is a holding member configured to hold the workpiece, and the second member is a contact member configured to contact the workpiece.

17. A robot system comprising the robot hand according to claim 1 and a robot arm.

18. A method of manufacturing an article using the robot system according to claim 17.

19. A control method for a robot hand that holds a workpiece, the robot hand including a first member configured to hold the workpiece, and a second member configured to contact the workpiece in a state where the workpiece is held by the first member, the control method comprising
changing the orientation of the workpiece by the first member or the second member being shifted in a state where the workpiece is held by the first member.

20. A non-transitory computer-readable recording medium storing a control program configured to execute the control method according to claim 19.
